(19) United States
(12) Patent Application Publication
(10) Pub. No.: US 2020/0031203 A1
(43) Pub. Date: Jan. 30, 2020

(54) Split Heat Exchanger Frame For Integrated HVAC Unit

(71) Applicants: DENSO International America, Inc., Southfield, MI (US); DENSO CORPORATION, Kariya-city (JP)

(72) Inventors: Reilly MULLETT, Livonia, MI (US); Simon HOTTE, Windsor (CA); Brandi STUECKRATH, Southfield, MI (US)

(21) Appl. No.: 16/049,117

(22) Filed: Jul. 30, 2018

(51) Int. Cl. B60H 1/32; F25B 39/02

(52) U.S. Cl. CPC B60H 1/3227; B60H 1/3233; F25B 39/028

(57) ABSTRACT

A heat exchanger for an integrated heating, ventilation, and air conditioning unit includes a core and a frame. The frame supports the core and includes a partition which defines a first compartment and a second compartment in the frame and seals a first portion of the core from a second portion of the core.

### FIELD

The present disclosure relates to a frame for a heat exchanger, and, more specifically, to a split heat exchanger frame for an integrated HVAC unit.

### BACKGROUND

This section provides background information related to the present disclosure which is not necessarily prior art.

Many vehicles, such as automotive vehicles, for example, include air conditioning or climate control systems to control a temperature within a cab or passenger compartment of the vehicle. These systems typically include a condenser or gas cooler, an evaporator, and a compressor circulating or pumping a refrigerant between the condenser and evaporator. Dual or integrated vehicle heating, ventilation, and air conditioning systems (HVAC) include multiple blowers, typically a front blower for a front area of the passenger cabin and a rear blower for a rear area of the passenger cabin. The evaporator and heater core may be split into a front system side and a rear system side. Existing dual/integrated HVAC systems may experience issues with air leaks between sides of the evaporator. This is often caused by the positioning or installation of the seal separating the sides of the HVAC evaporator.

### SUMMARY

This section provides a general summary of the disclosure, and is not a comprehensive disclosure of its full scope or all of its features.

An example heat exchanger for an integrated heating, ventilation, and air conditioning unit according to the present disclosure includes a core and a frame. The frame supports the core and includes a partition which defines a first compartment and a second compartment in the frame and seals a first portion of the core from a second portion of the core.

The first portion of the core may be configured to heat or cool a first compartment in a vehicle and the second portion of the core may be configured to heat or cool a second compartment in the vehicle.

The frame of the heat exchanger may be integrally formed.

The heat exchanger may further include a frame having a drain rib configured to provide water drainage off of the core.

The frame of the heat exchanger may be injection molded.

The heat exchanger may further include a frame having a plurality of fasteners and tabs, where the tabs act as stops to align the core within the frame.

The plurality of fasteners may snap fit to the core to retain the core in the frame.

The heat exchanger may further include a frame having protrusions on each corner that are configured to mate with channels in the integrated heating, ventilation, and air conditioning unit to align the heat exchanger in the integrated heating, ventilation, and air conditioning unit.

The partition sealing said first portion of the core from the second portion of the core may only be applied to a front face of the core and a back face of the core, with the front face being opposite the back face.

The frame of the heat exchanger may further include a partition having a plurality of pins that are inserted into the core to retain the partition in a predetermined position on the core.

The heat exchanger may further include packing applied only to an exterior of the frame.

An example of an integrated heating, ventilation, and air conditioning unit for a vehicle according to the present disclosure includes a housing, a first blower, a second blower and a heat exchanger. The first blower and the second blower direct airflow through the housing, and the heat exchanger is configured to receive air directed by the first blower and the second blower. The heat exchanger further includes a core and a frame. The frame supports the core and includes a partition that defines a first compartment and a second compartment in the frame and seals a first portion of the core from a second portion of the core.

The first portion of the core may be configured to direct airflow to a first compartment in the vehicle and the second portion of the core may be configured to direct airflow to a second compartment in the vehicle.

The frame and partition may be integrally formed.

The frame of the heat exchanger may further include a drain rib configured to provide water drainage off of the core. The frame, partition, and drain rib may be integrally formed.

The frame of the heat exchanger may be injection molded.

The frame of the heat exchanger may further include a plurality of fasteners and tabs. The tabs may act as stops to align the core within the frame. The plurality of fasteners may snap fit to the core to retain the core in the frame.

The frame of the heat exchanger may further include protrusions on each corner that are configured to mate with channels in the housing to align the heat exchanger in the housing.

The partition sealing the first portion of the core from the second portion of the core is only applied to a front face of the core and a back face of the core, where the front face is opposite the back face.

The partition may further include a plurality of pins that are inserted into the core to retain the partition in a predetermined position on the core.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of a dual or integrated climate control system according to the principles of the present disclosure.

FIG. 2 is a perspective view of a heat exchanger of the climate control system according to the principles of the present disclosure.

FIG. 3 is a cross sectional view of the heat exchanger cut at 3-3 in FIG. 2.

FIG. 4 is a cross sectional view of the heat exchanger cut at 4-4 in FIG. 2.

FIG. 5 is a frame for the heat exchanger of FIG. 2 according to the principals of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

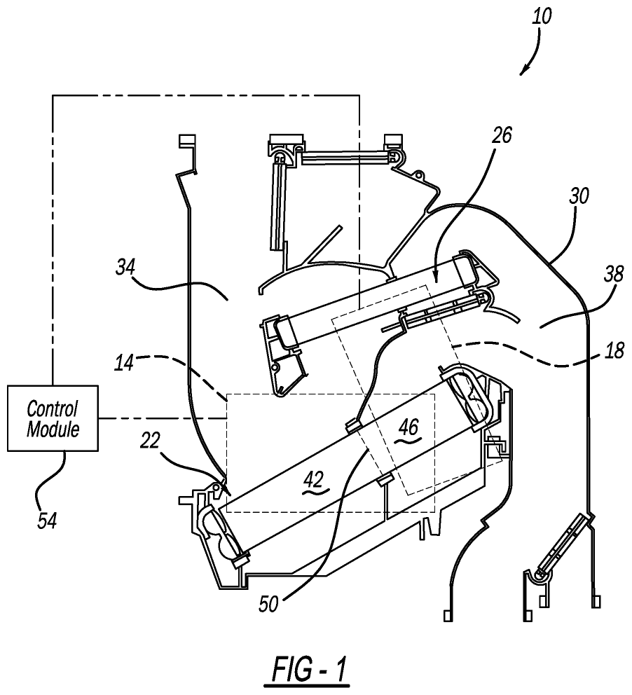

With initial reference to FIG. 1, an integrated heating, ventilation, and air conditioning system in accordance with the present teachings is illustrated at reference numeral 10. The HVAC system 10 may be a dual, integrated, HVAC system and can be used with any suitable vehicle in which it is desirable to include multiple HVAC blowers to direct air to both a front portion and a rear portion of a passenger cabin. The HVAC system 10 can be used with any suitable passenger vehicle (e.g., sedan, station wagon, van, minivan, sport utility vehicle, limousine, etc.), mass transit vehicle, military vehicle, aircraft, etc. The HVAC system 10 can also be used with any suitable non-vehicular application.

The HVAC system 10 generally includes a front blower 14 and a rear blower 18. The front blower 14 can be any suitable airflow generating device configured to direct airflow to a front area of a vehicle passenger cabin. The rear blower 18 can be any suitable device for generating and directing airflow to a rear area of the vehicle passenger cabin.

The HVAC system 10 further includes an evaporator 22. The front blower 14 and the rear blower 18 are both arranged to direct airflow through the evaporator 22 in the integrated HVAC example illustrated in FIG. 1. The HVAC system 10 may also include a heater core 26, and the blowers 14 and 18 may be arranged to direct airflow through the heater core 26 as well. The evaporator 22 and the heater core 26 are arranged in a case 30, which includes a front outlet 34 and a rear outlet 38. The front outlet 34 directs airflow to the front area of the vehicle passenger cabin, and the rear outlet 38 directs airflow to the rear area of the vehicle passenger cabin. The case 30 is configured to direct airflow generated by the front blower 14 through a front portion 42 of the evaporator 22. The case 30 is configured to direct airflow generated by the rear blower 18 through a rear portion 46 of the evaporator 22. The front portion 42 and the rear portion 46 are separated by a partition 50 (further described below). The front portion 42 is typically larger than the rear portion 46. For example, the front portion 42 can be 60% of, or about 60% of, the evaporator 22, and the rear portion 46 can be 40% of, or about 40% of, the evaporator 22.

The HVAC system 10 further includes a control module 54. In this application, including the definitions below, the term “control module” may be replaced with the term “circuit.” “Control module” may refer to, be part of, or include processor hardware (shared, dedicated, or group) that executes code and memory hardware (shared, dedicated, or group) that stores code executed by the processor hardware. The code is configured to provide the features of the control module and systems described herein. The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The control module 54 controls activation, deactivation, and speed of the front blower 14 and the rear blower 18. The control module 54 can also control activation and deactivation of the evaporator 22 and the heater core 26. For example, when a user requests activation of the front blower 14 and/or the rear blower 18 and the evaporator 22 to cool the front area and/or rear area of the vehicle passenger cabin, such as by entering a command using any suitable user interface (e.g., an electronic interface such as an instrument panel touch screen, or a mechanical interface such as a switch or knob) the control module 54 will sense such activation and automatically activate the front blower 14 and/or the rear blower 18 at least at a low speed.

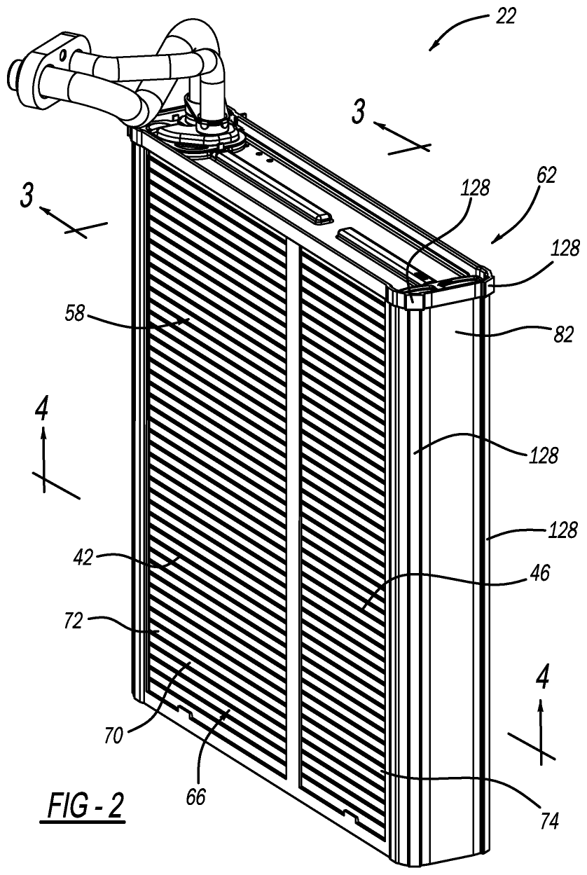

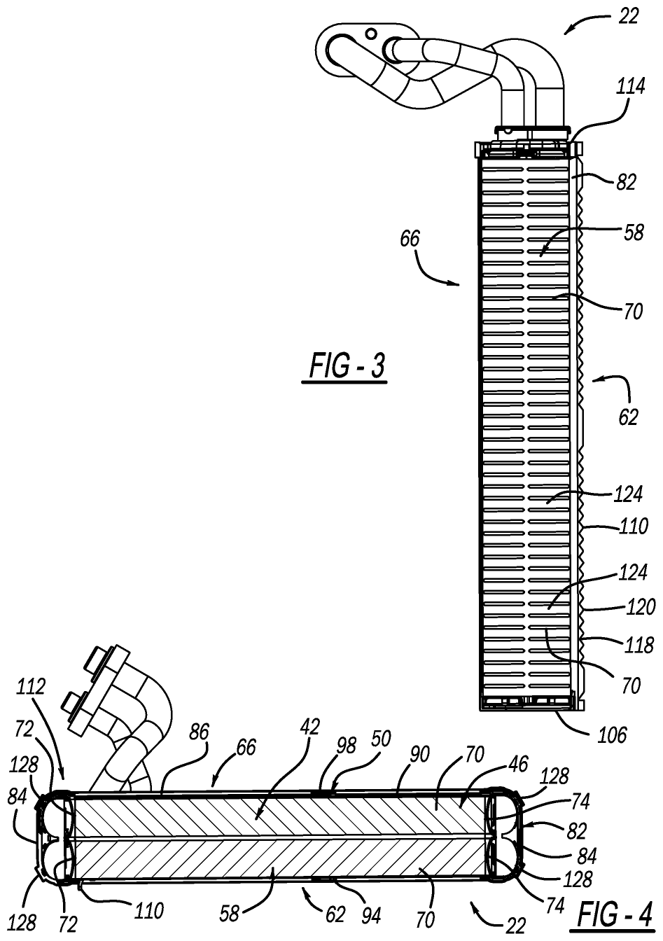

Now referring to FIGS. 2-4, the evaporator 22 is illustrated. The evaporator 22 may include an evaporator core 58 that is divided into the front portion 42 and the rear portion 46. The evaporator core 58 may further include a front face 62 and a rear face 66. The front face 62 may receive air from the heater core 26 and the rear face 66 may expel air to the front outlet 34 or the rear outlet 38. A plurality of fins 70 may extend longitudinally across the evaporator core 58, traversing both the front portion 42 and the rear portion 46. Each of the plurality of fins 70 is a flat plate having a first end 72 disposed in the front portion 42 and a second end 74 disposed in the rear portion 46.

A plurality of tubes (not shown) may extend orthogonal to, and through a plane on a face of each of the plurality of fins 70. In operation, the plurality of tubes may transport a liquid, such as coolant or refrigerant, across the front portion 42 and the rear portion 46 to cool the air blown through the plurality of fins 70 by the blower 14, 18.

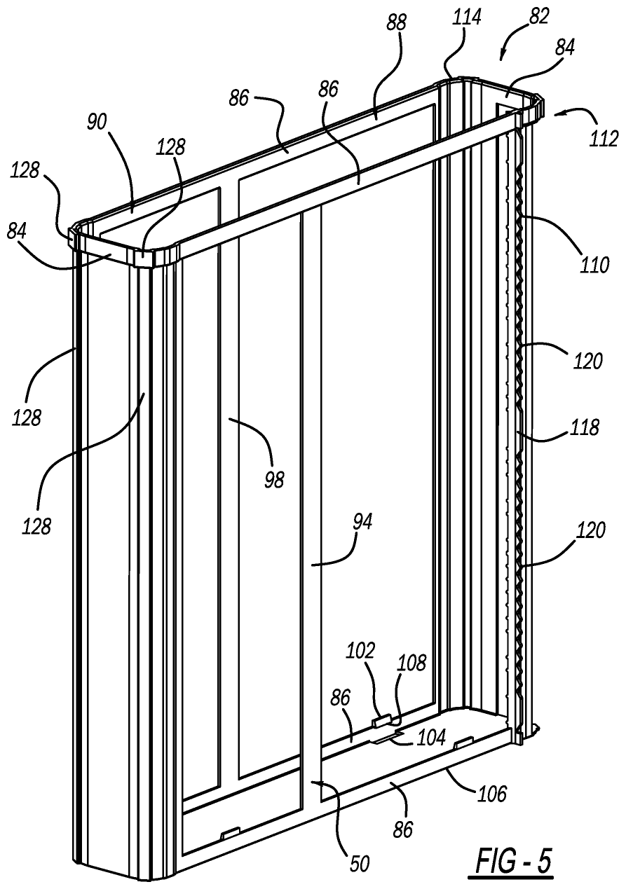

With additional reference to FIG. 5, a frame 82 may house the evaporator 22. The frame may include side plates 84 and cross beams 86 connecting the side plates 84. The frame 82 may include a front system side compartment 88 and a rear system side compartment 90 correlating to the front portion 42 and rear portion 46 of the evaporator 22. The front system side compartment 88 and the rear system side compartment 90 may be defined by the partition 50. Like the evaporator 22, the front system side compartment 88 may be larger than the rear system side compartment 90. For example, the front system side compartment 88 may be 60% of, or about 60% of, the frame 82, and the rear system side compartment 90 may be 40% of, or about 40% of, the frame 82.

Separating the front system side compartment 88 and the rear system side compartment 90 may be the partition 50, or a seal plate split rib 50. The seal plate split rib 50 may seal the front portion 42 and rear portion 46 of the evaporator core 58. The seal plate split rib 50 may include a front half 94 extending along the front face 62 of the evaporator core 58 and a rear half 98 extending along the rear face 66 of the evaporator core 58.

The seal plate split rib 50 may include fasteners (not shown), such as pins, that affix to one or more of the plurality of fins 70 on the evaporator core 58. In the case of pins, the pins may dig into the fins 70 to retain the seal plate split rib 50 against the fins 70. The seal plate split rib 50 may provide an airtight seal between the front system side compartment 88 and the rear system side compartment 90 to prevent introduction of air from one compartment to another.

Fasteners 102 and tabs 104 may be positioned along the cross beams 86. Specifically, fasteners 102 and tabs 104 may be positioned along the cross beams 86 on a bottom side 106 of the frame 82. Tabs 104 may act as a stop, limiting a distance in which the core 58 may be inserted into the frame 82. Once the core 58 contacts the tabs 104, the core 58 cannot be inserted further into the frame 82.

Fasteners 102 may snap-fit into the core 58. For example, fasteners 102 may include a step 108 that projects within a space 124 between ribs 70 in the core 58 and contacts a rib 70 to retain the core 58 within the frame 82. During assembly, the fasteners 102 may deform upon contact with the core 58. As the core 58 is further inserted onto the frame 82, the fasteners 102, and specifically the steps 108, snap into the space between ribs 70 in the core 58, securing the core 58 therein.

A drain rib 110 may be integrated along an end 112 of the frame 82 and extending from a top side 114 of the frame 82 to the bottom side 106 of the frame 82. The drain rib 110 may include a plate 118 having a plurality of pointed projections 120 that align with the space 124 between fins 70. The drain rib 110 may allow for proper water drainage off the evaporator core 58 by funneling water collected from each of the fins 70 of the evaporator core 58 and directing the flow to a drain tank (not shown).

The frame 82 may be an injection molded frame formed from a polymer, such as plastic. Injection molding the frame 82 from the polymer simplifies the assembly process of the evaporator 22, while better controlling the position of the seal plate split rib 50. Additionally, injection molding the frame 82 allows the frame to be easily re-sizable for different evaporator core dimensions.

During assembly, the evaporator core 58 is inserted into the frame 82 by aligning the front portion 42 with the front system side compartment 88 and the rear portion 46 with the rear system side compartment 90 and sliding the evaporator core 58 in the frame 82. The evaporator core 58 is inserted into the frame 82 until the evaporator core 58 contacts tabs 104. As the core 58 is inserted into the frame 82 and contacts fasteners 102, the fasteners 102 deform. When the core 58 contacts the tabs 104 of the frame 82, the fasteners 102 are aligned with the space between ribs 70, and the steps 108 of the fasteners 102 snap into the space between ribs 70 in the core 58, securing the core 58 therein.

The evaporator core 58 and frame 82 is inserted into the case 30. The frame 82 may include projections 128 on its corners that align with channels in the case 30. As such, the frame 82 may be easily assembled with the case 39. Assembly is then complete. The integral nature of the frame allows for simple, easy-to-execute steps during assembly.

The frame 82 may additionally house and/or integrate packing material and any additional parts that would otherwise be applied during assembly of the evaporator 22. By having the packing and additional parts be included in the injection molded frame 82, the assembly process of the evaporator 22 is greatly simplified and errors during assembly are reduced. With the packing applied to the frame 82 instead of the evaporator core 58 directly, evaporator core 58 erosion is alleviated. By integrating the split evaporator seal plate 50 and drain rib 106 in the frame 82 design, these parts do not need to be assembled to the evaporator core 58 and their placement is ensured to be precise. The split evaporator seal plate 50 and drain rib 106 positioning consistency is improved thereby improving the overall sealing condition and functioning of the HVAC unit.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A heat exchanger for an integrated heating, ventilation, and air conditioning unit comprising:
a core; and
a frame supporting said core,
wherein said frame includes a partition defining a first compartment and a second compartment in said frame and sealing a first portion of said core from a second portion of said core.

2. The heat exchanger of claim 1, wherein said first portion of said core is configured to heat or cool a first compartment in a vehicle and said second portion of said core is configured to heat or cool a second compartment in said vehicle.

3. The heat exchanger of claim 1, wherein said frame is integrally formed.

4. The heat exchanger of claim 1, wherein said frame further includes a drain rib configured to provide water drainage off of said core.

5. The heat exchanger of claim 1, wherein said frame is injection molded.

6. The heat exchanger of claim 1, wherein said frame further includes a plurality of fasteners and tabs, said tabs acting as stops to align said core within said frame.

7. The heat exchanger of claim 6, wherein said plurality of fasteners snap fit to said core to retain said core in said frame.

8. The heat exchanger of claim 1, wherein said frame further includes protrusions on each corner that are configured to mate with channels in said integrated heating, ventilation, and air conditioning unit to align said heat exchanger in said integrated heating, ventilation, and air conditioning unit.

9. The heat exchanger of claim 1, wherein said partition sealing said first portion of said core from said second portion of said core is only applied to a front face of said core and a back face of said core, said front face being opposite said back face.

10. The heat exchanger of claim 9, wherein said partition includes a plurality of pins that are inserted into said core to retain said partition in a predetermined position on said core.

11. The heat exchanger of claim 1, further comprising packing applied only to an exterior of said frame.

12. An integrated heating, ventilation, and air conditioning unit for a vehicle comprising:
a housing;
a first blower and a second blower directing airflow through said housing; and
a heat exchanger configured to receive air directed by said first blower and said second blower,
wherein said heat exchanger includes:
a core; and
a frame supporting said core,
said frame having a partition that defines a first compartment and a second compartment in said frame and seals a first portion of said core from a second portion of said core.

13. The integrated heating, ventilation, and air conditioning unit of claim 12, wherein said first portion of said core is configured to direct airflow to a first compartment in said vehicle and said second portion of said core is configured to direct airflow to a second compartment in said vehicle.

14. The integrated heating, ventilation, and air conditioning unit of claim 12, wherein said frame and partition are integrally formed.

15. The integrated heating, ventilation, and air conditioning unit of claim 12, wherein said frame further includes a drain rib configured to provide water drainage off of said core, said frame, partition, and drain rib being integrally formed.

16. The integrated heating, ventilation, and air conditioning unit of claim 12, wherein said frame is injection molded.

17. The integrated heating, ventilation, and air conditioning unit of claim 12, wherein said frame further includes a plurality of fasteners and tabs, said tabs acting as stops to align said core within said frame and said plurality of fasteners snap fitting to said core to retain said core in said frame.

18. The integrated heating, ventilation, and air conditioning unit of claim 12, wherein said frame further includes protrusions on each corner that are configured to mate with channels in said housing to align said heat exchanger in said housing.

19. The integrated heating, ventilation, and air conditioning unit of claim 12, wherein said partition sealing said first portion of said core from said second portion of said core is only applied to a front face of said core and a back face of said core, said front face being opposite said back face.

20. The integrated heating, ventilation, and air conditioning unit of claim 19, wherein said partition includes a plurality of pins that are inserted into said core to retain said partition in a predetermined position on said core.
